(19) United States
(12) Patent Application Publication
(10) Pub. No.: US 2004/0240451 A1
(43) Pub. Date: Dec. 2, 2004

(54) Connection handling, service management, and channel handling devices of home network management system

(76) Inventors: Koon-Seok Lee, Changwon-Shi (KR); Seung-Myun Baek, Changwon-Shi (KR); Yong-Tae Kim, Gimhae-Shi (KR); Hwan-Jong Choi, Buk-Ku (KR); Feel-Young Koo, Suyoung-Ku (KR); Ja-In Koo, Jinju-Shi (KR); Sung-Hwan Kang, Kyungsangnam-Do (KR)

Correspondence Address: FLESHNER & KIM, LLP, P.O. BOX 221200, CHANTILLY, VA, 20153, US

(21) Appl. No.: 10/854,807

(22) Filed: May 27, 2004

(30) Foreign Application Priority Data
May 30, 2003 (KR) 10-2003-0034962
Feb. 6, 2004 (KR) 10-2004-0007869
Feb. 6, 2004 (KR) 10-2004-0007872
Feb. 6, 2004 (KR) 10-2004-0007874
Feb. 6, 2004 (KR) 10-2004-0007876

(51) Int. Cl. H04L 12/56

(52) U.S. Cl. 370/395.5; 370/401

(57) ABSTRACT

The present invention relates to a home network management system, and more particularly to, connection handling, service management, and channel handling devices of a home network management system which can perform processing, conversion and transmission of data between a plurality of client devices and a plurality of home appliances. A channel handling device of the home network management system residing in a home master device connected to at least one home appliance through a first network and connected to at least one client device through a second network separated from the first network, and being controlled by a central processing means of the home master device, transmits/receives a first type of packet between a first device within the home master device and the home appliance.

### TECHNICAL FIELD

The present invention relates to a home network management system, and more particularly to, connection handling, service management, and channel handling devices of a home network management system which can perform processing, conversion and transmission of data between a plurality of client devices and a plurality of home appliances.

### BACKGROUND ART

Home automation for automatically controlling home appliances at home or remotely has almost reached a commercial use stage. At its early stage, the home automation separately controlled each home appliance by using a telephone or infrared rays, and did not connect the home appliances. However, there has been suggested a method for building a network of home appliances by using a communication means, and collectively managing the network by using a controller.

FIG. 1 is a structure view illustrating a general home network system. Referring to FIG. 1, a home network connects various digital home appliances so that a user can always enjoy convenient, safe and economical life services inside or outside the house.

As factors of the advent of the home network, refrigerators or washing machines called white home appliances have been gradually digitalized due to development of digital signal processing techniques, and new information home appliances have been made due to rapid development of home appliance operating system techniques and high speed multimedia communication techniques.

Here, an IT network is built to exchange data between a personal computer and peripheral devices or provide internet services, and an AV network is built between home appliances using audio or video information. In addition, a living network is built to simply control home appliances, such as home automation or remote meter reading, and may be comprised of a refrigerator, washing machine, microwave oven, electric lamp, gas alarm, air conditioner and telephone.

The home network system includes a master device which is a home appliance for controlling an operation of the other home appliances or monitoring a status thereof, and a slave device which is a home appliance having a function of responding to the request of the master device and a function of notifying a status change according to properties of the home appliances or other factors. Here, the home appliances include home appliances for the living network service such as a washing machine and a refrigerator as well as home appliances for the IT network service and the AV network service.

However, the conventional home network system does not provide a message defined as a predetermined type between the master device and a client device such as a remote control server for transmitting/receiving a monitoring command and a control command for the home appliances to/from the master device.

In addition, the conventional home network system does not provide a message defined as a predetermined type between the master device and the slave device.

Furthermore, when the message transmitted between the client device and the master device and the message transmitted between the master device and the slave device are defined as different types, the conventional home network system is not able to process such messages.

### DISCLOSURE OF THE INVENTION

An object of the present invention is to provide connection handling, service management, and channel handling devices of a home network management system which can provide a message defined as a predetermined type between a plurality of client devices and a master device and which can also provide a message defined as a predetermined type between the master device and a slave device.

Another object of the present invention is to provide connection handling, service management, and channel handling devices of a home network management system which can achieve normalization in operation of a home network system through a normalized message, by using a predefined message having information on a monitoring command and a control command for home appliances.

Yet another object of the present invention is to provide connection handling, service management, and channel handling devices of a home network management system which can perform processing, conversion and transmission of messages in a home network system using different message structures.

Yet another object of the present invention is to provide connection handling, service management, and channel handling devices of a home network management system which enables a plurality of client devices and a plurality of home appliances to perform communication through different networks.

Yet another object of the present invention is to provide connection handling, service management, and channel handling devices of a home network management system which can communicate with a plurality of home appliances according to a plurality of communication access methods.

Yet another object of the present invention is to provide connection handling, service management, and channel handling devices of a home network management system which can process packets and messages by a living network control protocol.

In order to achieve the above-described objects of the invention, there is provided a channel handling device of the home network management system residing in a home master device connected to at least one home appliance through a first network and connected to at least one client device through a second network separated from the first network, and being controlled by a central processing means of the home master device, transmitting/receiving a first type of packet between a first device within the home master device and the home appliance.

According to another aspect of the invention, a service management device of the home network management system residing in a home master device connected to at least one home appliance through a first network and connected to at least one client device through a second network separated from the first network, and being controlled by a central processing means of the home master device performs conversion between a first type of message from a first device and a second type of message from a second device, and transmits the converted messages to the first device or the second device.

According to yet another aspect of the invention, a connection handling device of the home network management system residing in a home master device connected to at least one home appliance through a first network and connected to at least one client device through a second network separated from the first network, and being controlled by a central processing means of the home master device performs conversion between a first type of extension message from the client device and the first type of message from the first device of the home master device.

### BRIEF DESCRIPTION OF THE DRAWINGS

The present invention will become better understood with reference to the accompanying drawings which are given only by way of illustration and thus are not limitative of the present invention, wherein:

FIG. 1 is a structure view illustrating a general home network system;

FIG. 2 is a structure view illustrating a home network system to which a home network management system is applied in accordance with the present invention;

FIGS. 3a to 3c are structure views illustrating a first type of packets by LnCP and LnCPa;

FIG. 4 is a structure view illustrating a second type of message by LnCPb;

FIG. 5 is a structure view illustrating the home network management system in accordance with the present invention;

FIG. 6 is a structure view illustrating a channel handling module of FIG. 5;

FIG. 7 is a structure view illustrating a transmission handling module of FIG. 5;

FIG. 8 is a structure view illustrating a service management module of FIG. 5;

FIG. 9 is a structure view illustrating a device handling module of FIG. 5; and

FIG. 10 is a structure view illustrating a connection handling module of FIG. 5.

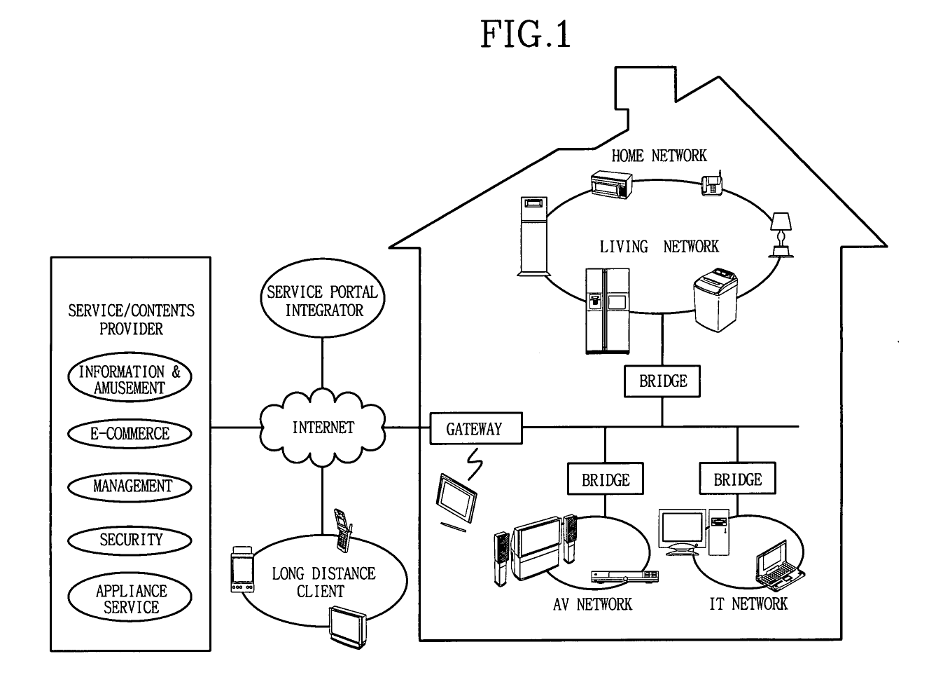

### BEST MODE FOR CARRYING OUT THE INVENTION

Connection handling, service management, and channel handling devices of a home network management system in accordance with the present invention will now be described in detail with reference to the accompanying drawings.

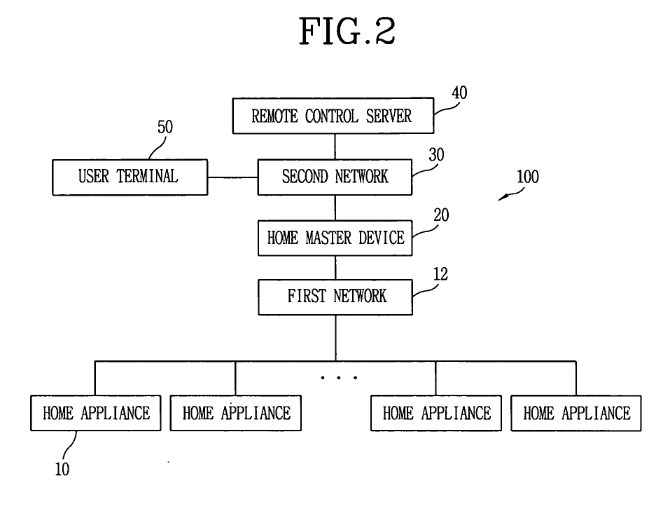

FIG. 2 is a structure view illustrating a home network system to which the home network management system is applied in accordance with the present invention.

Referring to FIG. 2, the home network system 100 includes a plurality of home appliances 10, a home master device 20 connected to the plurality of home appliances 10 through a first network 12, for monitoring and controlling the home appliances 10, a second network 30 for performing communication among the home master device 20, a remote control server 40 and a user terminal 50, the remote control server 40 for generating monitoring and control commands, and transmitting the commands to the home master device 20 through the second network 30, and the user terminal 50 for allowing the user to access the remote control server 40 through the second network 30 and monitor or control the home appliances 10 and/or the home master device 20.

In detail, the plurality of home appliances 10 communicate with the home master device 20 through the first network 12 by using a first type of packet by living network control protocol a (LnCPa). Here, each of the home appliances 10 is registered in the home master device 20, provided with unique logical addresses (for example, 0x00, 0x01, etc.), and identified by the logical addresses.

The first network 12 can be a wire medium such as a specially-installed line, or a power line or telephone line previously installed in a house and/or building, or a wireless transmission medium.

Identically to the aforementioned master device, the home master device 20 performs communication by using the first type of packet by the LnCPa in order to monitor and control the home appliances 10 which are slave devices. The home master device 20 communicates with the remote control server 40 through the second network 30 for basic communication (for example, login request and response, dummy signal, logout request and response, etc.), and monitoring response or control command and response, by using a second type of extension message by living network control protocol b (LnCPb).

When receiving power or an operation start command from the user, the home master device 20 is connected to the remote control server 40 through the second network 20 by a login procedure automatically or by the command of the user. The login procedure is performed by using a general ID and password (ID information stored respectively in the home master device and the remote control server). The home master device 20 transmits a login request message to the remote control server 40, and the remote control server 40 processes the login request message and transmits a login response message to the home master device 20. After the home master device 20 is connected to the remote control server 40 by the login procedure, the home master device 20 transmits a dummy signal (or message) to the remote control server 40 at a predetermined time interval in order to confirm communication access. In addition, the home master device 20 transmits a logout request message to the remote control server 40 by a logout procedure, and the remote control server 40 processes the logout request message and transmits a logout response message to the home master device 20.

The second network 30 includes, for example, an internet, and further includes other constitutional elements according to a kind of the user terminal 50. That is, when the user terminal 50 is a computer, a web server (not shown) is connected between the second network 30 and the user terminal 50, and when the user terminal 50 is an internet phone, a Wap server (not shown) is connected between the second network 30 and the user terminal 50.

The first network 12 and the second network 30 are separated networks. The first network 12 composes a closed network (separated from the second network) for connecting the home appliances through a wire or wireless transmission medium. Here, the closed network includes a physically-connected but logically-divided network.

Thereafter, the remote control server 40 is connected to the home master device 20 and the user terminal 50 by login and logout procedures, for receiving the monitoring and control commands from the user terminal 50, and transmitting them to the home master device 20 through the second network 30 in the form of a second type of message by the LnCPb. In addition, the remote control server 40 receives a second type of message by the LnCPb from the home master device 20, and stores or transmits the message to the user terminal 50.

Exemplary user terminals 50 include all devices accessible to the second network 30, such as a personal computer, mobile wireless terminal, PDA, web pad and home automation device. Hereinafter, the remote control server 40 and the user terminal 50 are referred to as client devices, and the client device accesses the home master device 20 through the second network 30.

The structure of the first type of packet by the LnCPa and the structure of the second type of message by the LnCPb will now be explained.

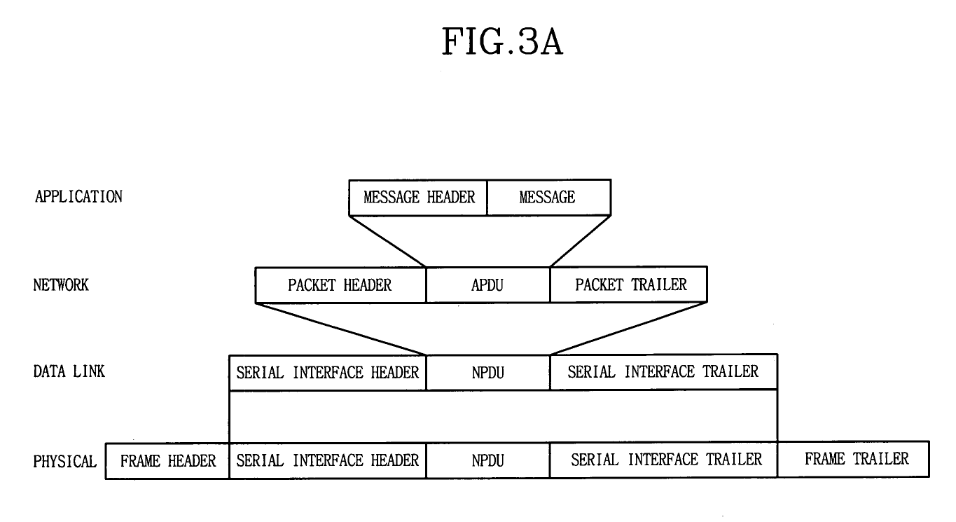

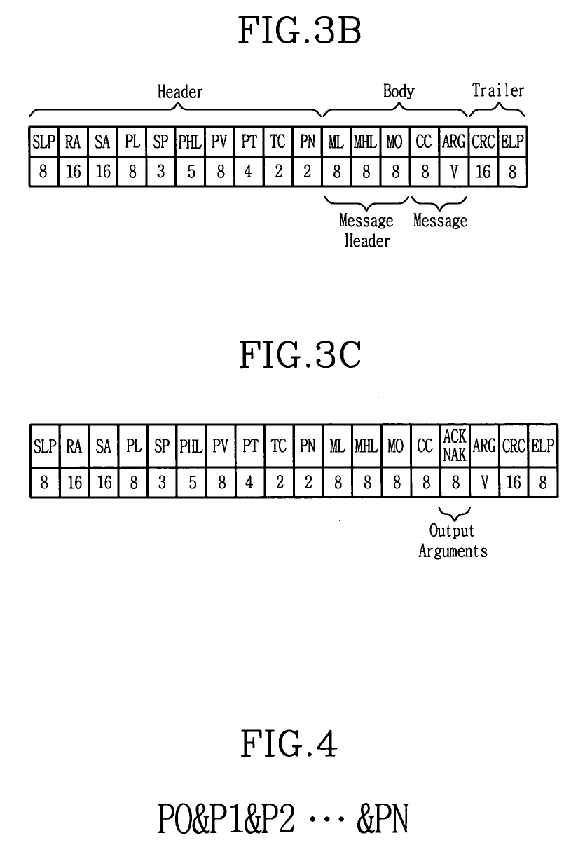

FIGS. 3a to 3c are structure views illustrating the first type of packets by the LnCP and the LnCPa.

As shown in FIG. 3a, the LnCP includes an application layer, a network layer, a data link layer and a physical layer. Each interface between the layers combines header and/or trailer information on the basis of a protocol data unit (PDU) from an upper layer, and generates a new protocol information unit for a lower layer.

The interfaces between the layers are formed on the basis of an application PDU (APDU) between the application layer and the network layer, a network layer PDU (NPDU) between the network layer and the data link layer, and a data frame unit between the data link layer and the physical layer.

The information units generated in each layer include headers. For example, when the network layer receives an APDU (comprised of message header and message) from the application layer, the network layer generates an NPDU by adding a packet header and a packet trailer having information on an address of a sender, an address of destination and a kind of packet by significance of the transmitted message, and transmits the NPDU to the data link layer. In the same manner, when the data link layer receives the NPDU from the upper network layer, the data link layer generates a frame for the physical layer by adding a serial interface header and a frame trailer.

FIG. 3b is a structure view illustrating one example of the first type of packet by the LnCPa.

As depicted in FIG. 3b, the first type of packet by the LnCPa includes a header region having packet header fields and fields for adding packet functions, a body region having message header fields, fields for adding message functions and message fields, and a trailer region.

A request or notification packet includes 8 bits of SLP field for displaying the start of the packet, 16 bits of receiver address (RA) field for displaying a receiver, 16 bits of sender address (SA) field for displaying a sender, 8 bits of packet length (PL) field for displaying a length of the packet, 3 bits of service priority (SP) field for displaying transmission priority, 5 bits of packet header length (PHL) field for displaying a length of a packet header, 8 bits of protocol version (PV) field for displaying a version of a protocol, 4 bits of packet type (PT) field for displaying a type of the packet, 2 bits of transmission counter (TC) field for displaying a retransmission number, 2 bits of packet number (PN) field for displaying new packet transmission, 8 bits of message length (ML) field, 8 bits of message header length (MHL) field, 8 bits of message option (MO) field, 8 bits of command code (CC) field, an argument (ARG) field having a variable bit number, 16 bits of error check (CRC) field, and 8 bits of ELP field for displaying the end of the packet, and has a minimum value of 17 bytes and a maximum value of 255 bytes. Here, the SP field, the PHL field, the PV field, the PT field, the TC field and the PN field are fields for network layer control (NLC) in the network layer.

As illustrated in FIG. 3c, a response packet is identical to the response/notification packet of FIG. 3b, except for 8 bits of ACK/NAK in the body region.

The SLP (0x02) field for displaying the start of the packet is a redundant field for detecting an error of the packet.

The RA field is positioned before the SA field, for deciding in advance whether the receiver receiving the packet intends to continuously receive or ignore the packet. From the upper bits, 2 bits are allocated to distinguish a kind of networks, 6 bits are allocated to distinguish products having individual functions, such as a washing machine and a refrigerator, and 8 bits are allocated to distinguish a plurality of products of the same kind.

The PL field is a 1 byte field for storing a number calculated in byte units of the packet from a home code (HC) to ELP. When receiving the PL data value, the receiver receives data corresponding to the value, and performs the succeeding step thereon. Accordingly, the PL is used to notify a size of a necessary buffer in reception in advance, and to detect an error of the packet data. That is, when the receiver reads the last byte of the packet, if the value is not the ELP, the packet is deemed to have an error.

The SP field gives priority to an urgent message from the application layer, a packet that must be retransmitted due to transmission failure, or a message that is less important than general communication, and displays transmission priority so that the physical layer can perform CSMA/CD function. The SP field is meaningful only when transmission by priority is possible in an adapter having the CSMA/CD function. The SP values in each communication state are as follows.

0: retransmission due to collision, or emergency

1: mass data transmission by message division

2: normal communication

3: network access state report (priority is 3 in collision)

The PHL field is a field for extension of the packet header. When an extension field is added to the packet header, the length of the packet header is changed. If nothing is changed, the PHL field is 9 bytes and can be extended to a maximum value of 32 bytes.

The PV field is a 1 byte field for displaying the version of the protocol. The version and the sub-version have a value of 0 to 15 in an update order.

The PT field is a 4 bit field designated in transmission of the packet and divided into a request packet, a response packet and a notification packet. The response packet is divided into a successful response and a failed response. Accordingly, although the data link layer is not informed of message contents, if the PT field of the packet header shows the failed response, the data link layer does not transmit the packet to the application layer but retransmit the packet. A notification packet means a packet which does not require a response. In high speed mass data transmission, an arrayed packet is used to divide the whole data and transmit the divided data without responses to each packet. The hexa-values of the arrayed packet are as follows.

0: Request packet

1˜3: Reserved

4: Successful response packet

5: Failed response packet

6˜7: Reserved

8: Broadcast notification packet

9: Arrayed packet

10: End packet of arrayed data

11˜15: Reserved

The TC field is a 2 bit field for preventing redundant processing of the same message when a communication error is generated. When the response packet received by the home master device 20 includes a CRC error code or when the received packet has a CRC error or reception byte time over, the packet can be retransmitted by maximally three times. An initial value is set to be ‘0’ and increased by ‘1’ in every retransmission. The home appliance 10 always transmits the packet one time.

The PN field is also a 2 bit field for preventing redundant processing of the same message when a communication error occurs. Whenever the home master device 20 transmits a new packet, it increases the packet number by ‘1’. When the home master device 20 retransmits the same packet, it maintains the same packet number. Therefore, the home appliance 10 memorizes the packet number and the sender address of the previous message, ignores reception of the same message, and processes a different message. When responding to the received message, the home appliance 10 copies the packet number of the received message and forms the response packet.

Here, an HC field can be added to the left side of the NPDU. The HC logically distinguishes network-configured houses. Especially, when transmission lines between the houses are connected like power lines, the HC is used within the range of 0x03 to 0x FE to distinguish the houses.

The ML field notifies a variable length of the message field. The application layer obtains the length of the message field from the length of the message.

The MHL field is a field for future extension of the message field. The message header can be added in the cases of encoding of the message field and variation of the application protocol.

The MO field for extension of message sets divides the message sets by ports. The message sets can be disposed by ports for version-up or compatibility with the other application protocols.

The message is comprised of a command code which the home master device 20 uses to request execution of functions to the home appliance 10, input factors which the home appliance 10 requires to perform the command, and factors which the home appliance 10 transmits to the home master device 20 after execution of the command. In addition, the message must be formed and defined to simplify program operations in an 8 bit level microcomputer. That is, modular programming must be embodied to easily reflect addition/deletion of the message. For this, the whole messages must be provided with individual functions. It means that the whole messages do not include subordinate concept messages and do not have causal relations with each routine in S/W implementation. In the case that the messages have individual functions, the messages can be combined to extend the functions for controlling and monitoring the products. If the home appliance 10 normally performs the command, the factors transmitted to the home master device 20 are ACK+return arguments, and if not, the factors are NAN+error code. Each device has essentially maximally 256 commands. The existence/absence and byte number of input arguments and return arguments are determined according to the command code.

The data types of the arguments are as follows.

boolean: 1 byte

char, unsigned char: 1 byte

int, unsigned int, short int, unsigned short int: 2 byte

long, unsigned long: 4 byte

string: transmitted/received including NULL

The following basic concepts are used to classify the command codes.

Although all the products individually use 256 (0x00-0x FF) command codes, the command commonly used for the products uses a common code. The functions of the products are added to the generalized structure so as to easily add/delete items.

The CRC field detects an error of the received packet, or allows the receiver to detect the error of the packet in transmission. The CRC field has 16 bits, and generates a value or detects an error by using the data in the bytes from the ELP field to the field before the CRC field.

The ELP field (0x03) shows communication characters implying the end of the packet, and provides a method for detecting an error of a packet without using the CRC field with the PL field in reception. That is, when a predetermined byte of data corresponding to the length of the packet is received, if the last byte is not the ELP, the packet is deemed to have an error. Here, checking the error of the packet using the CRC field can be omitted.

FIG. 4 is a structure view illustrating the second type of message by the LnCPb. As illustrated in FIG. 4, the message is transmitted between the home master device 20 and the client devices and comprised of a plurality of parameters P0 to PN. Each of the parameters P0 to PN is distinguished by predetermined delimiters (for example, &). The parameters P0 to PN and the delimiters are formed without an empty space.

Here, P0 denotes an ID code of a sender (user terminal) regardless of a kind of the message. For example, when a plurality of client devices access the home master device 20, P0 is required to distinguish the client devices. However, P0 can be selectively included in the message.

Exemplary messages include a message for basic communication, a message for monitoring and a message for controlling. A parameter P1 denotes a product code unit, a parameter P2 denotes a message code unit, a parameter P3 denotes a number unit of parameters, and parameters P4 to PN denote parameter units under the definition of the message.

The message for basic communication includes the login request and response messages, the dummy signal, and the logout request and response messages. The structure of the message will now be explained.

In detail, the product code unit includes a product ID code and a logical address of the corresponding home appliance 10. For example, the product ID code is a character type, such as ‘CC’ of an air conditioner and ‘Wm’ of a washing machine, and the logical address is a number type, such as ‘0x01’ and ‘0x02’. The product ID code and the logical address of the product code unit are consecutively formed without an empty space, such as ‘CC01’ and ‘Wm02’.

The message code unit shows a transmission/reception direction of the message, and includes at least one of a first code region for displaying the message from the home master device 20 to the client device, and a second code region for displaying the message from the client device to the home master device 20. For example, the first code region includes numbers of 0 to 99 and the second code region includes numbers of 100 to 199 not to overlap with each other. That is, when the message is transmitted from the home master device 20 to the client device, the message code unit includes one number of the first code region, for example, ‘4’, and when the message is transmitted from the client device to the home master device 20, the message code unit includes one number of the second code region, for example, ‘110’.

Each of the parameter units has values under the definition of the message, and the number unit of the parameters displays a number N-3 of the parameters.

The product code unit, the message code unit, the parameter units and the number unit of the parameters are distinguished by predetermined delimiters (for example, &). The message sequentially includes the product code unit, the message code unit, the number unit of the parameters, and the parameter units.

The message includes the message for monitoring the home appliance 10. Here, the message includes the product code unit, the message code unit and the number unit of the parameters of the message for basic communication, and also includes different parameters P4 to PN.

In detail, each of the parameter units includes a user ID code unit P4, an internet operation program code command unit P5 for identifying the home appliance 10, a command unit P6 for the home appliance 10, a number unit P7 of return arguments, and return argument units P8 to PN.

The user ID code unit P4 corresponds to the ID of the login information registered in the client device, and includes at least characters. For example, the user ID code unit P4 is used in the form of ‘id=jaeeny’.

The internet operation program code command unit P5 includes a recognition code iopc for an internet operation program, a product ID code and a command, and has a type of ‘recognition code=product ID code_command’. For example, the internet operation program code command unit P5 includes ‘iopc=wm_exe_message’, which implies an execution message exe_message for a washing machine wm, and may also include ‘file_down_send’ for downloading a predetermined file to the home master device 20.

The command unit P6 includes a factor name and a factor value of the command, and has a type of ‘factor name comm_code=factor value’. For example, the command unit P6 includes ‘comm_code=209’. Here, the factor value includes a command for the home appliance 10.

The number unit P7 of the return arguments implies a number N-7 of the return arguments.

Each of the return argument units P8 to PN includes a return argument name and a factor value, and has a type of ‘name=factor value’. For example, the return argument units P8 to PN include ‘A1=300’, ‘ws=0 (washing setting is 0, namely main operation)’, and ‘rs=0 (rinse setting is 0, namely normal)’. In addition, each of the return argument units P8 to PN further includes a byte number of the factor value. For example, when the return argument units P8 to PN include ‘A1=2_{—}300’, the return argument A1 is 2 bytes and has a value of 300.

Each of the parameter units sequentially includes the user ID code unit, the internet operation program code command unit, the command unit, the number unit of the return arguments, and the return argument units. The user ID code unit, the internet operation program code command unit, the command unit, the number unit of the return arguments, and the return argument units are distinguished by predetermined delimiters (for example, &).

Finally, the message includes the control message for the home appliance 10. The control message includes the product code unit, the message code unit and the number unit of the parameters of the message for basic communication, and also includes different parameters P4 to PN.

Each of the parameter units includes a user ID code unit P4, a destination IP unit P5 for the home master device 20, a language unit P6, an internet operation program code command unit P7 for identifying the home appliance 10, a command unit P8 for the home appliance 10, a number unit P9 of arguments, and argument units P10 to PN.

In detail, the user ID code unit P4, the internet operation program code command unit P7 and the command unit P8 are identical to the user ID code unit P4, the internet operation program code command unit P5 and the command unit P6 of the message for monitoring.

The destination IP unit P5 includes an address of the home master device 10. For example, the destination IP unit P5 includes ‘remote_addr=165.186.30.228’. The language unit P6 displays a kind of the language used in the message. For example, the language IP unit P5 includes ‘lang=ko’ or ‘lang=en’. Here, ‘ko’ implies Korean and ‘en’ implies English.

The number unit P9 of the arguments means a number N-9 of the arguments.

Each of the argument units P10 to PN includes an argument name and a factor value, and has a type of ‘name=factor value’. For example, the argument units P10 to PN include ‘A1=300’. In addition, each of the argument units P10 to PN further includes a byte number of the factor value. For example, when the argument units P10 to PN include ‘A1=2_{—}300’, the argument A1 is 2 bytes and has a value of 300.

Each of the argument units P10 to PN sequentially includes the user ID code unit P4, the destination IP unit P5, the language unit P6, the internet operation program code command unit P7, the command unit P8, the number unit P9 of the arguments, and the argument units P10 to PN. Here, the user ID code unit P4, the destination IP unit P5, the language unit P6, the internet operation program code command unit P7, the command unit P8, the number unit P9 of the arguments and the argument units P10 to PN are distinguished by predetermined delimiters (for example, &).

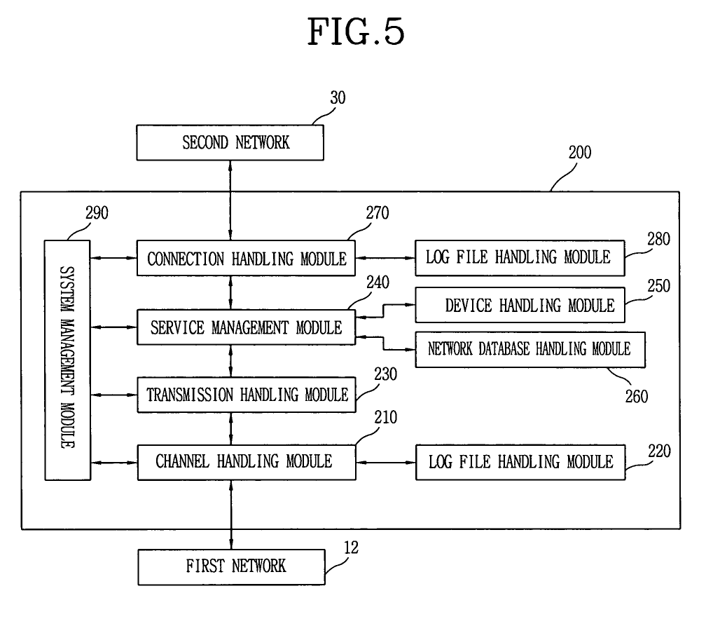

FIG. 5 is a structure view illustrating the home network management system in accordance with the present invention. The home network management system 200 resides in the home master device 20, and is controlled by a central processing means (not shown) of the home master device 20. The home network management system 200 is a software program residing in a storage means (not shown) of the home master device 20, or hardware or middleware installed in the home master device 20.

The home network management system 200 includes a channel handling module 210 for transmitting/receiving a first type of packet between the home master device 20 and the home appliance 10, a transmission handling module 230 for performing conversion between the first type of packet from the channel handling module 210 and a first type of message from a service management module 240, and transmitting the converted packet and message, the service management module 240 for performing conversion between the first type of message from the transmission handling module 230 and a second type of message from a connection handling module 270, and transmitting the converted messages, and the connection handling module 270 for performing conversion between a second type of extension message from the client device and the second type of message from the service management module 240. The modules receive the packets and/or messages, process the packets and/or messages when the objects of the packets and/or messages are themselves, and convert/transmit the packets and/or messages when the objects are the other modules.

In addition, the home network management system 200 further includes a system management module 290 for performing an initialization operation for communication with the client device and/or the home appliance 10 by using necessary variables of the channel handling module 210, the transmission handling module 230 and the service management module 240.

In detail, the channel handling module 270, the service management module 240 and the transmission handling module 230 have individual variables, respectively. The channel handling module 270 has a communication port number, a communication medium and parameters defined in a data link layer and a physical layer, the service management module 240 has an address of the home appliance 10 used by a message blocking handling means 243 (discussed later) for transmission/reception blocking, a control command and a parameter defined in an application layer, and the transmission handling module 230 has a parameter defined in a network layer. Such variables are set and varied by the system management module 290.

The system management module 290 opens the communication port, determines a communication speed, initializes the variables, and confirms the list and operation state of the connected home appliances 10 as the initialization operations for the home network communication.

The home network management system 200 further includes a log file handling module 220 for storing the first type of packet transmitted/received through the channel handling module 210.

In addition, the home network management system 200 further includes a device handling module 250 for directly performing conversion between the first type of message and the second type of message. The device handling module 250 can be added to the service management module 240 as a sub module.

The home network management system 200 further includes a network database handling module 260 for storing a state and information of the home appliance 10.

The home network management system 200 further includes a log file handling module 280 for storing the second type of extension message transmitted/received through the connection handling module 270.

The home network management system 200 includes a message queue (not shown) which is a transmission path of the whole packets and/or messages. The message queue is stored in a storage means (not shown) of the home master device 20 or a storage means (not shown) of the home network management system 200. Two methods for transmitting packets and/or messages by using a message queue will now be described.

First, one message queue exists. The message queue receives packets and/or messages having types corresponding to reception modules from the arbitrary module of the modules and stores the packets and/or messages, and the modules search the message queue at a predetermined time interval and obtain the packets and/or messages having the types corresponding to each module. Here, the message queue deletes the packets and/or messages obtained by the modules.

Second, the message queues exist as many as the modules. The arbitrary module of the modules transmits and stores packets and/or messages having types corresponding to reception modules in the message queues of the reception modules, and the reception modules search their message queues and obtain the packets and/or messages having the types. Here, the message queues delete the packets and/or messages obtained by the modules.

The interfaces between the modules will now be explained.

The connection handling module 270 communicates with the client device, the service management module 240 and the system management module 290. First, the connection handling module 270 transmits/receives the second type of extension message for the interface with the client device, provides a message ID code to the second type of extension message, and stores the message in the log file handling module 280. The message ID code is useful to efficiently identify a plurality of client devices during login/logout and file download processes with the client devices, and to confirm transmission of divided files of one file and/or restore the divided files into the original file.

In addition, the second type of extension message processed by the connection handling module 270 includes an ID code of the client device, a message code and a second type of message. Here, the ID code of the client device is used to distinguish the plurality of client devices connected to the home master device 20, and the message code is comprised of a logical address of the home appliance included in the second type of message and a control command. The connection handling module 270 reads the message code and the second type of message from the extension message, and transmits them to the service management module 240. The message code confirms a pair of the message transmitted/received between the connection handling module 270 and the service management module 240, and transmits the confirmed message to the client device. In the case that the plurality of client devices access the home master device 20, the connection handling module 270 processes a plurality of second type of extension messages, and transmits the messages to the service management module 240.

As described above, in the communication with the system management module 290, the connection handling module 270 reads the message code and the second type of message, and transmits them to the system management module 290.

The interface between the service management module 240 and the transmission handling module 230 will now be explained.

For the interface between the service management module 240 and the transmission handling module 230, the message transmitted to the message queue includes a message type, an auxiliary factor and a first type of message. The auxiliary factor is varied according to the transmission direction and contents of the first type of message.

First, when the message includes a control command from the service management module 240 to the transmission handling module 230, the auxiliary factor includes an ID code (for example, logical address) of the home appliance 10 to be controlled, and a packet type. Here, the message may further include service priority. When the message includes a response from the transmission handling module 230 to the service management module 240, the auxiliary factor includes an ID code of the home appliance 10 performing the control command, and a reception error code. Here, the reception error code includes CRC or timeout (limit execution time exceeded).

In addition, when the message includes a control command from the transmission handling module 230 to the service management module 240, the auxiliary factor includes an ID code of the home appliance 10 for performing the control command, a packet type, a duplicate reception flag and a reception error code. When the message includes a response from the service management module 240 to the transmission handling module 230, the auxiliary factor includes an ID code of the home appliance 10 performing the control command, and a packet type.

The non-described interfaces between the modules are formed by using a predetermined message type of packets and/or messages through the message queues.

As discussed earlier, the home network management system 200 employs the message queue to transmit the packets and/or messages. For convenience’ sake, it is presumed hereinafter that the packets and/or messages are directly transmitted between the modules.

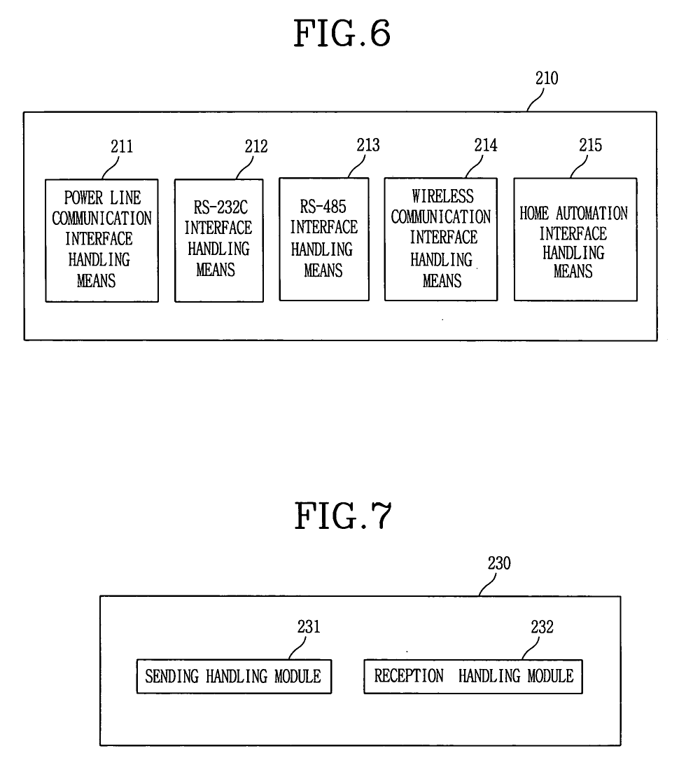

FIG. 6 is a structure view illustrating the channel handling module of FIG. 5.

The channel handling module 210 controls a plurality of communication ports, and thus has a plurality of modules for interfaces with the communication ports. The home master device 20 is connected to the home appliances 10 through the first network 12. The first network 12 is one of power line communication, RS-232C, RS-485 and wireless communication. The channel handling module 210 transmits the first type of packet to a driver module corresponding to the communication method.

As driver modules for the communication interfaces, the channel handling module 210 includes a power line communication interface handling means 211 by an asynchronous serial communication standard for providing an interface with a power line communication modem (not shown) for the power line communication, an RS-232C interface handling means 212 by an asynchronous serial communication standard for providing direct communication with the home appliances 10, an RS-485 interface handling means 213 by an asynchronous serial communication standard for providing an interface with an RS-485 adapter (not shown), and a wireless communication interface handling means 214 by an asynchronous serial communication standard for providing an interface with a wireless modem (not shown).

For communication between the home master device 20 and a home automation device (not shown), the channel handling module 210 further includes a home automation interface handling means 215 for providing an interface with an adapter (not shown) for controlling the home automation-related home appliances 10 among the home appliances 10.

The channel handling module 210 transmits the first type of packets from the plurality of means for the interfaces to the transmission handling module 230, and also transmits the first type of packets to the other interface handling means. That is, the channel handling module 210 serves as a kind of arbitrator.

The channel handling module 210 also transmits and stores the first type of packet in the log file handling means 220.

FIG. 7 is a structure view illustrating the transmission handling module of FIG. 5.

The transmission handling module 230 transmits/receives the first type of packet to/from the channel handling module 210, and transmits/receives the first type of message to/from the service management module 240. The transmission handling module 230 includes a sending handling module 231 and a reception handling module 232.

The sending handling module 231 generates a first type of packet by using the first type of message and the auxiliary factor from the service management module 240, and sends the packet to the channel handling module 210. When the sending handling module 231 does not receive a first type of response packet from the corresponding home appliance 10, the sending handling module 231 retransmits the packet. While waiting for the response packet, the sending handling module 231 receives another first type of message and auxiliary factor from the service management module 240, processes the message and factor, and transmits them to the channel handling module 210.

The reception handling module 232 separates an error check field and a first type of message from the first type of packet from the channel handling module 210, and transmits them to the service management module 240.

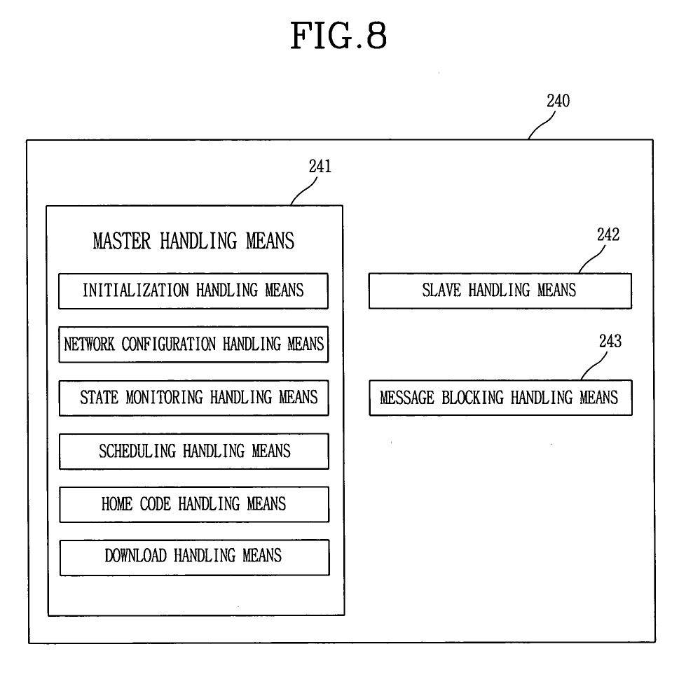

FIG. 8 is a structure view illustrating the service management module of FIG. 5.

In addition to conversion between the first type of message and the second type of message (described in the explanations of the device handling module), the service management module 240 receives the second type of message from the connection handling module 270, and transmits the message to a corresponding inside module (discussed later) according to the contents of the message.

When the home appliances 10 receiving the plurality of first type of messages converted from the plurality of second type of messages inputted from the connection handling module 270 are identical, the service management module 240 ends one cycle for one first type of message and transmits the succeeding first type of message to the transmission handling module 230, and when the home appliances 10 are different, the service management module 240 consecutively transmits the first type of messages to the transmission handling module 230.

Here, one cycle communication includes one request one response communication cycle for ending communication when the home master device 20 transmits one request message to one home appliance 10 and receives one response message from the home appliance 10, one request multiple response communication cycle for ending communication when the home master device 20 transmits one request message to the plurality of home appliances 10, receives one response message from each home appliance 10 and continuously waits for the responses, and when a maximum reception time elapses, and one notification communication cycle for ending communication when the home master device 20 transmits one notification message to one or the plurality of home appliances 10. The first type of message belongs to one of the communication cycles. The service management module 240 decides whether one cycle ends in the communication cycle of the first type of message.

Still referring to FIG. 8, the service management module 240 includes a master handling means 241, a slave handling means 242 and a message blocking handling means 243.

The master handling means 241 performs a master function on the home appliances 10 and/or client devices. The master handling means 241 includes an initialization handling means for performing an initialization operation when the home master device 20 is initially executed, a network configuration handling means for performing functions of discovering a new home appliance 10, and allocating and deleting an address, a state monitoring handling means for monitoring the home appliance 10 by periodically receiving state data having an operation state from the home appliance 10, a scheduling handling means for processing a reservation message from the connection handling module 270, a home code handling means for receiving a message relating to home code setting from the connection handling module 270, and setting a home code in a modem (not shown) of the home appliance 10 in a predetermined order, and a download handling means for receiving a message for downloading data from the connection handling module 270 to the home appliance 10, and uploading the data to the home appliance 10.

In detail, when the network configuration handling means discovers a new home appliance 10, it transmits a request message to the connection handling module 270 to obtain library and information of the product corresponding to the home appliance 10, and receives the library and information from the client device (for example, remote control server).

The state monitoring handling means transmits the state data to the connection handling module 270 to be transmitted to the client device. When the state data are deficient, the state monitoring handling means non-periodically receives the state data from the corresponding home appliance 10 and monitors the home appliance 10.

The service management module 240 transmits and stores the home appliance-related information in the network database handling module 260.

The slave handling means 242 receives a message from another home master device 20 (when a plurality of home master devices exist), so that the home master device 20 can perform a slave function.

The message handling means transmits or blocks the first type of message. The message handling means includes a sending message hooking means for blocking the converted first type of message from the connection handling module 270 according to the home appliance to be controlled and/or a control command, and a reception message hooking means for blocking the first type of message from the transmission handling module 230 according to the home appliance 10 and/or the executed control command.

For example, in the case of a gas valve among the home appliances 10, although a control command for opening/closing the gas valve is supported, the user or the home master device 20 can also disable a function of opening/closing the gas valve for safety. Here, when the receiver receiving the converted first type of message from the connection handling module 270 is the gas valve, if the command code of the message is the control command for opening/closing the gas valve, the sending message hooking means blocks the message. In addition, when receiving the first type of message from the non-registered home appliance 10, the reception message hooking means blocks the message.

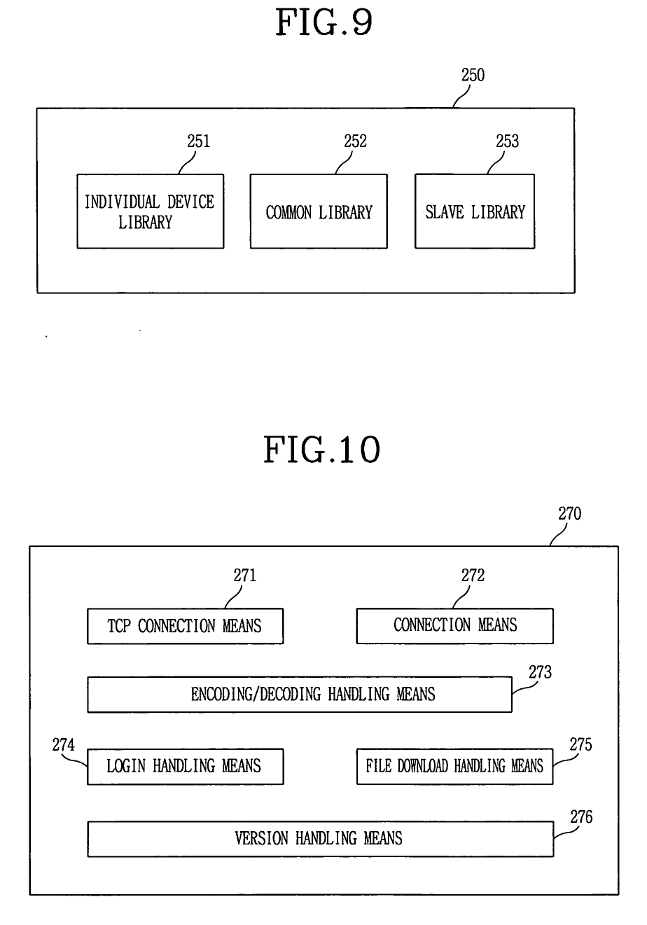

FIG. 9 is a structure view illustrating the device handling module of FIG. 5.

The device handling module 250 directly performs conversion between the first type of message and the second type of message. Here, the device handling module 250 receives the message having the control command for the home appliance 10 from the service management module 240 (or connection handling module 270) (when the device handling module is a sub module of the service management module), and generates and transmits the second type of message. In addition, the device handling module 250 converts the first type of message from the service management module 240 (or transmission handling module 230) (when the device handling module is a sub module of the service management module) into the second type of message, and transmits the converted message. The conversion process will now be described in detail.

The device handling module 250 includes an individual device library 251 for converting messages for the home appliances 10 registered in the home master device 20, a common library 252 for converting messages for the home appliances 10 which are not registered in the home master device 20 (or home network system 100), and a slave library 253 for converting the first type of message in the case of the command for the whole home appliances 10.

Especially, when the message included in the second type of message has a group address (indicating at least two home appliances), the home network management system 200 processes the message by using the common library 252.

In detail, the individual device library 251 stores product names, model information and commands for the home appliances 10 registered in the home master device 20, and the common library 252 stores information and commands commonly applied to the home appliances 10 which are not registered in the home master device 20. However, when the common command for the whole home appliances 10 is generated, the slave library 253 processes the message.

The conversion process between the first type of message and the second type of message will now be explained.

For example, the second type of message is as follows.

‘wr00&171&8&id=jaeeny&remote_addr=165.186.30.228&lang=
en&iopc=wr_exe_message&comm_code=5&1’

Here, ‘wr’ denotes a washing machine, ‘0x00’ denotes a logical address of the washing machine, ‘0x05’ denotes a control command code (power control command), and ‘0x01’ denotes a factor (operation command). A receiver address is extracted from ‘wr00’, and a command code and a factor value are extracted according to the value of iopc. That is, when the product code of the washing machine is ‘0x0A’, the address (receiver address) of the washing machine which is the reception home appliance 10 is ‘0x0A00’, and the command code and the factor are ‘0x05’ and ‘0x01’. Therefore, the first type of message (APDU) becomes ‘0x05 0x03 0x00 0x05 0x01’, which implies a length of the APDU, a header length of the APDU, an option value, a command code and a factor, respectively.

For example, the first type of message is as follows.

‘0x 05 0x03 0x00 0x05 0x06’

The washing machine wr is confirmed by an address of a sender (home appliance 10) from an auxiliary factor from the transmission handling module 230. An ACK response for a command code ‘0x05’ is confirmed by ‘0x06’. In addition, this message is a response message, and thus an iopc value includes monitoring. The thusly-generated second type of message is as follows.

‘wr00&71&7&id=test&iopc=wr_monitoring&comm_code=
192&return_args_no=0’

FIG. 10 is a structure view illustrating the connection handling module of FIG. 5.

The connection handling module 270 exchanges the second type of extension message between the client device and the home master device 20 so as to control the home appliances 10 or set environment variables or management variables through the system management module 290. When receiving the second type of extension message, the connection handling module 270 processes the message in an inside module (discussed later), or reads the second type of message and transmits the message to the service management module 240 or the system management module 290. In addition, the connection handling module 270 stores the received second type of extension message in the log file handling module 280.

The connection handling module 270 includes at least one TCP connection means 271 (or port) for communication with the client device. The TCP connection means 271 is a port for communication with the remote control server 40 among the client devices. The connection handling module 270 may include a connection means 272 (or port) for communication with the other client devices.

The connection handling module 270 also includes an encoding/decoding handling means 273 for encoding and decoding the second type of extension message during the communication with the client device, a login handling means 274 for automatically logging in the client device (at least remove control server 40) by using the login information stored in the storage means of the home master device 20, whenever the home master device 20 is operated, a file download handling means 275 for downloading a file from the client device, and storing the file in the storage means of the home master device 20, when receiving a file download message from the client device, and a version handling means 276 for downloading information of the home network management system 200 from the client device, and storing the information in the storage means of the home master device 20, when receiving a new version of information of the home network management system 200 from the client device. The login handling means 274 confirms the communication access by periodically transmitting dummy data to the client device. The file download handling means 275 transmits the download result to the service management module 240.

As discussed earlier, in accordance with the present invention, the home network management system provides the message defined as a predetermined type between the plurality of client devices and the master device and also provides the packet and/or message defined as a predetermined type between the master device and the slave device.

The home network management system achieves normalization in operation of the home network system through the normalized packet and/or message, by using the predefined message having information on the monitoring command and the control command for the home appliances.

In addition, the home network management system performs processing, conversion and transmission of the packets and/or messages in the home network system using different message structures.

The home network management system enables the plurality of client devices and the plurality of home appliances to perform communication through different networks.

Furthermore, the home network management system communicates with the plurality of home appliances according to the plurality of communication access methods.

The home network management system processes the packets and messages by the LnCP.

Although the preferred embodiment of the present invention has been described, it is understood that the present invention should not be limited to this preferred embodiment but various changes and modifications can be made by one skilled in the art within the spirit and scope of the present invention as hereinafter claimed.

1. A channel handling device of the home network management system residing in a home master device connected to at least one home appliance through a first network and connected to at least one client device through a second network separated from the first network, and being controlled by a central processing means of the home master device, the channel handling device transmitting/receiving a first type of packet between a first device within the home master device and the home appliance.

2. The channel handling device of claim 1, wherein the channel handling device transmits/receives the first type of packet through a message queue of the home master device, wherein the channel handling device transmits the first type of packet comprising a type corresponding to the first device to the message queue, and receives the first type of packet comprising a type corresponding to the channel handling device from the message queue.

3. The channel handling device of claim 1, further comprising one message queue which is a transmission path of the first type of packet, wherein the channel handling device transmits the first type of packet comprising a type corresponding to the first device to a message queue of the first device, and receives the first type of packet comprising a type corresponding to the channel handling device from the message queue of the channel handling device.

4. The channel handling device of claim 1, wherein the first device is a transmission handling device of the home network management system.

5. The channel handling device of claim 1, wherein the channel handling device is connected to the home appliance through at least one communication port.

6. The channel handling device of claim 5, wherein the channel handling device transmits the first type of packet received from the first device to the driver module corresponding to the communication port.

7. The channel handling device of claim 6, further comprising a power line communication interface handling means by an asynchronous serial communication standard for providing an interface with a power line communication as driver module.

8. The channel handling device of claim 6, further comprising an RS-232C interface handling means by an asynchronous serial communication standard for providing direct communication with the home appliance as driver module.

9. The channel handling device of claim 6, further comprising an RS-485 interface handling means by an asynchronous serial communication standard for providing an interface with an RS-485 adapter as driver module.

10. The channel handling device of claim 6, further comprising a wireless communication interface handling means by an asynchronous serial communication standard for providing an interface with a wireless modem as driver module.

11. The channel handling device of claim 6, further comprising a home automation interface handling means by an asynchronous serial communication standard for providing an interface with an adapter for controlling the home automation-related home appliances among the home appliance as driver module.

12. The channel handling device of claim 7, wherein the channel handling device transmits a first type of packet received from one interface handling means to another interface handling means.

13. The channel handling device of claim 1, wherein the channel handling device transmits the transmitted/received first type of packet to log file handling means of the home network management system.

14. The channel handling device of claim 1, wherein the first type is living network control protocol.

15. The channel handling device of claim 14, wherein the first type is living network control protocol a.

16. A service management device of the home network management system residing in a home master device connected to at least one home appliance through a first network and connected to at least one client device through a second network separated from the first network, and being controlled by a central processing means of the home master device, the service management device performing conversion between a first type of message from a first device and a second type of message from a second device, and transmitting the converted messages to the first device or the second device.

17. The service management device of claim 16, wherein the service management device transmits/receives the messages through a message queue of the home master device, wherein the service management device transmits the first type or the second type of message comprising a type corresponding to the first or the second device to the message queue, and receives the first type or the second type of message comprising a type corresponding to the service management device from the message queue.

18. The service management device of claim 16, further comprising one message queue which is a transmission path, wherein the service management device transmits the first type or the second of message comprising a type corresponding to the first or the second device to a message queue of the first or the second device respectively, and receives the message comprising a type corresponding to the service management device from the message queue of the service management device.

19. The service management device of claim 16, wherein the first device is a transmission handling device of the home network management device, and the second device is a connection handling device of the home network management device.

20. The service management device of claim 17, wherein the message transmitted to the message queue for communication between the service management device and the first device includes an auxiliary factor and the first type of message.

21. The service management device of claim 20, wherein the auxiliary factor includes an identification code of the home appliance, a service priority and a message type when the message includes a control command from the service management device to the first device.

22. The service management device of claim 21, wherein the auxiliary includes a identification code of the home appliance and a reception error code when the message includes a response from the service management device.

23. The service management device of claim 20, wherein the auxiliary factor includes an identification code of the home appliance, a message type, duplicate reception flag and a reception error code when the message includes a control command from the first device to the service management device.

24. The service management device of claim 21, wherein the auxiliary includes a identification code of the home appliance and a message type when the message includes a response from the service management device.

25. The service management device of claim 16, wherein the service management device ends one cycle for the first type of message and transmits the succeeding first type of message to the first device when the receivers of the plurality of first type of messages converted from the plurality of second type of messages are identical, or the service management device consecutively transmits the first type of messages to the first device when the receivers of the plurality of the first type of messages are different.

26. The service management device of claim 16, wherein the service management device processes the message internally when the receiver of the message is the service management device.

27. The service management device of claim 26, further comprising a master handling means performing a master function on the home appliances and/or client devices.

28. The service management device of claim 27, wherein the master handling means includes an initialization handling means for performing an initialization operation for communication when the home master device is initially executed.

29. The service management device of claim 27, wherein the master handling means includes a network configuration handling means for performing functions of discovering a new home appliance, and allocating and deleting an address.

30. The service management device of claim 29, wherein the network configuration handling means transmits a request message about information on the new home appliance.

31. The service management device of claim 27, wherein the master handling means includes a state monitoring handling means for monitoring the home appliance by periodically receiving state data having an operation state from the home appliance.

32. The service management device of claim 31, wherein the state monitoring handling means transmits the state data to the client device.

33. The service management device of claim 31, wherein the state monitoring handling means non-periodically receives the state data from the corresponding home appliance and monitors the home appliance.

34. The service management device of claim 27, wherein the master handling means includes a scheduling handling means for processing a reservation message from the second device.

35. The service management device of claim 27, wherein the master handling means includes a home code handling means for receiving a message relating to home code setting from the second device, and setting a home code in a modem of the home appliance in a predetermined order.

36. The service management device of claim 27, wherein the master handling means includes a download handling means for receiving a message for downloading data from the second device to the home appliance, and uploading the data to the home appliance.

37. The service management device of claim 26, further comprising a slave handling means receiving a message from another home master device for performing a slave function.

38. The service management device of claim 26, further comprising the message handling means processing the received first type of message.

39. The service management device of claim 38, wherein the message handling means includes a means for blocking the converted first type of message from the second device according to the home appliance to be controlled and a control command.

40. The service management device of claim 38, wherein the message handling means includes a means for blocking the first type of message from the first device according to the home appliance and the executed control command.

41. The service management device of claim 16, further comprising a device handling means receiving the message having the control command for the home appliance, generating and transmitting the second type of message, converting the first type of message from the home appliance into the second type of message and transmitting the converted message.

42. The service management device of claim 41, wherein the device handling means includes an individual device library for converting messages for the home appliances registered in the home master device.

43. The service management device of claim 42, wherein the device handling means includes a common library for converting messages for the home appliances which are not registered in the home master device.

44. The service management device of claim 43, wherein the device handling means processes a message by using the common library when the message included in the second type of message has a group address.

45. The service management device of claim 43, wherein the device handling means includes a slave library for converting the first type of message in the case of the command for the whole home appliances.

46. The service management device of claim 16, wherein the first and second type are living network control protocols.

47. The service management device of claim 46, wherein the first type is living network control protocol a.

48 The service management device of claim 46, wherein the second type is living network control protocol b.

49. A connection handling device of the home network management system residing in a home master device connected to at least one home appliance through a first network and connected to at least one client device through a second network separated from the first network, and being controlled by a central processing means of the home master device, the connection handling device performing conversion between a first type of extension message from the client device and the first type of message from the first device of the home master device.

50. The connection handling device of claim 49, wherein the connection handling device transmits/receives the messages through a message queue of the home master device, wherein the connection handling device transmits the first type of message comprising a type corresponding to the first device to the message queue, and receives the type of message comprising a type corresponding to the connection handling device from the message queue.

51. The connection handling device of claim 49, further comprising one message queue which is a transmission path of the first type of message, wherein the connection handling device transmits the first type of message comprising a type corresponding to the first device to a message queue of the first device, and receives the first type of packet comprising a type corresponding to the connection handling device from the message queue of the connection handling device.

52. The connection handling device of claim 49, wherein the connection handling device provides an identification code to the received first type of extension message.

53. The connection handling device of claim 50, wherein the connection handling device stores the message including the identification code and the first type of message.

54. The connection handling device of claim 50, wherein the first device is a service management device of the home network management system.

55. The connection handling device of claim 49, wherein the first type of extension message includes an identification code of the client device, message code and the first type of message.

56. The connection handling device of claim 55, wherein the connection handling device reads the first type of message from the first type of the extension message and transmits them to the first device.

57. The connection handling device of claim 49, further comprising an encoding/decoding handling means for encoding and decoding the first type of extension message during the communication with the client device.

58. The connection handling device of claim 49, further comprising a login handling means for automatically logging in the client device by using the login information stored in a storage means of the home master device, whenever the home master device is operated.

59. The connection handling device of claim 58, wherein the login handling means transmits dummy data to the client device periodically.

60. The connection handling device of claim 49, further comprising a file download handling means for downloading a file from the client device, and storing the file in a storage means of the home master device, when receiving a file download message from the client device.

61. The connection handling device of claim 60, wherein the file download handling means transmits the download result to the first device.

62. The connection handling device of claim 49, further comprising a version handling means for downloading information of the home network management system from the client device, and storing the information in the storage means of the home master device, when receiving a new version of information of the home network management system from the client device.

63. The connection handling device of claim 49, further comprising at least one TCP port for communication with the client device.

64. The connection handling device of claim 63, wherein the TCP port is a port for communication with the remote control server among the client devices.

65. The connection handling device of claim 63, further comprising a port for communication with the other client devices.

66. The connection handling device of claim 49, wherein the connection handling device stores the received first type of extension message in a log file handling module of the home master device.

67. The connection handling device of claim 49, wherein the first type is living network control protocol.

68. The connection handling device of claim 67, wherein the first type is living network control protocol b.
